(19) United States
(12) Patent Application Publication
(10) Pub. No.: US 2011/0024457 A1
(43) Pub. Date: Feb. 3, 2011

(54) Shower Soap Dispenser

(76) Inventor: Alan Somerfield, Lincoln (GB)

Correspondence Address: Dr. BANGER SHIA;Patent Office of Bang Shia, 102 Lindencrest Ct, Sugar Land, TX, 77479-5201, US

(21) Appl. No.: 12/844,332

(22) Filed: Jul. 27, 2010

(30) Foreign Application Priority Data
Jul. 28, 2009 (GB) 0913112.9

(51) Int. Cl. B67D 7/06; G01F 11/00

(52) U.S. Cl. 222/145.1; 222/214; 222/57; 222/71

(57) ABSTRACT

A shower soap dispenser contains a turbine including a turbine housing, and the turbine housing including a turbine inlet, a turbine outlet, a jet, and a plurality of turbine blades; a gearbox including an input and an output; a pump including a pump inlet and a pump outlet; a soap reservoir connected to the pump via a connector to store soap; a clutch mechanism clutch mechanism located in the gearbox control to engage the turbine with the pump or disengage the turbine from the pump, when the turbine engages with the pump, the pump is turned on by the turbine, when the turbine disengages with the pump, the pump turns off; means for turning the addition of soap on and off to be pulled or pushed to open or close the soap outlet and to allow the clutch mechanism to engage and to force the clutch mechanism to disengage.

### BACKGROUND OF THE INVENTION

1. Field of the Invention

The present invention relates to a shower soap dispenser that is capable of introducing an additive to liquid flowing within a conduit so as to be used in machinery lubrication, pharmaceutical and agricultural industries, etc.

2. Description of the Prior Art

The prior art in this field may be roughly divided between two techniques. Firstly and most prevalent is the idea of using a venturi suction pump to withdraw the soap from an adjacent container. Unfortunately the statutory introduction of flow restrictors into showers in the interests of water economy has rendered this approach unworkable because the restrictor increases the pressure in the pipe above the level that a venturi can overcome. Even without flow restrictors the design of modern showers which include mechanisms for aerating the water flow also raise the pressure in the pipe. It should be noted that the addition of soap into a shower is most effective when the shower is set to an aeration function that mixes air with the water flow. The addition of air bubbles into the water flow causes the soap to foam greatly which produces a highly satisfying shower spa experience.

Another technique uses an obstruction in the fluid flow to create a pressure drop that is then applied across a flexible container holding the additive thus squeezing it into the fluid flow. Whilst this is workable solution it is complex and expensive to produce especially due to the need for a large pressure vessel and the large forces that are generated. With this approach it is also difficult to precisely control the amount of soap used due to the need for a very small orifice at the exit of the soap container which means that the delivery rate of soap will depend on the orifice size and this is difficult to control in production. This viscosity dependency also makes it difficult to design the product so the user can choose the soap to be used as the viscosity variation will result in widely varying soap usage rates.

The present invention has arisen to mitigate and/or obviate the afore-described disadvantages.

### SUMMARY OF THE INVENTION

The primary object of the present invention is to provide a shower soap dispenser is capable of overcoming the shortcomings of the conventional shower soap dispenser.

To obtain the above objectives, a shower soap dispenser provided by the present invention contains:
a turbine including a turbine housing, and the turbine housing including a turbine inlet connected to the turbine housing to flow water inward, a turbine outlet to flow soap outward, a jet disposed therein and communicating with the turbine inlet, and a plurality of turbine blades axially fixed therein and pushed by water flow from the jet to rotate;
a gearbox mounted on the turbine housing and including an input connected to a first shaft of the turbine housing and an output connected to a second shaft to change rotating speed;
a pump including a pump inlet and a pump outlet and driven by the output of the gearbox to operate;
a soap reservoir connected to the pump via a connector to store soap, and the soap in the soap reservoir being pumped into the pump inlet by the pump and pumped into the turbine outlet from the pump outlet;
a clutch mechanism clutch mechanism located in the gearbox control to engage the turbine with the pump or disengage the turbine from the pump, when the turbine engages with the pump, the pump is turned on by the turbine, when the turbine disengages with the pump, the pump turns off;
means for turning the addition of soap on and off to be pulled or pushed to open or close the soap outlet and to allow the clutch mechanism to engage and to force the clutch mechanism to disengage.

### BRIEF DESCRIPTION OF THE DRAWINGS

FIG. 1 is a plan view showing a shower soap dispenser being installed on a water supply according to a first embodiment of the present invention;

FIG. 2 is a perspective view showing the cross section of the shower soap dispenser according to the first embodiment of the present invention;

FIG. 3 is another perspective view showing the cross section of the shower soap dispenser according to the first embodiment of the present invention;

FIG. 4 is a plan view showing the disengagement of a clutch mechanism of the shower soap dispenser according to the first embodiment of the present invention;

FIG. 5 is a plan view showing the engagement of the clutch mechanism of the shower soap dispenser according to the first embodiment of the present invention;

FIG. 6 is a perspective view showing the assembly of a shower soap dispenser according to a second embodiment of the present invention;

FIG. 7 is a perspective view showing a soap cartridge being removed from the shower soap dispenser according to the second embodiment of the present invention;

FIG. 8 is a perspective view showing the assembly of a cartridge storage device according to the second embodiment of the present invention;

FIG. 9 is a plan view showing a double soap cartridge being removed from a shower soap dispenser according to a third embodiment of the present invention;

FIG. 10 is a cross sectional view showing the assembly of a pump of the shower soap dispenser according to the first embodiment of the present invention;

FIG. 11 is a plan view showing the assembly of a gearbox of the shower soap dispenser according to the first embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

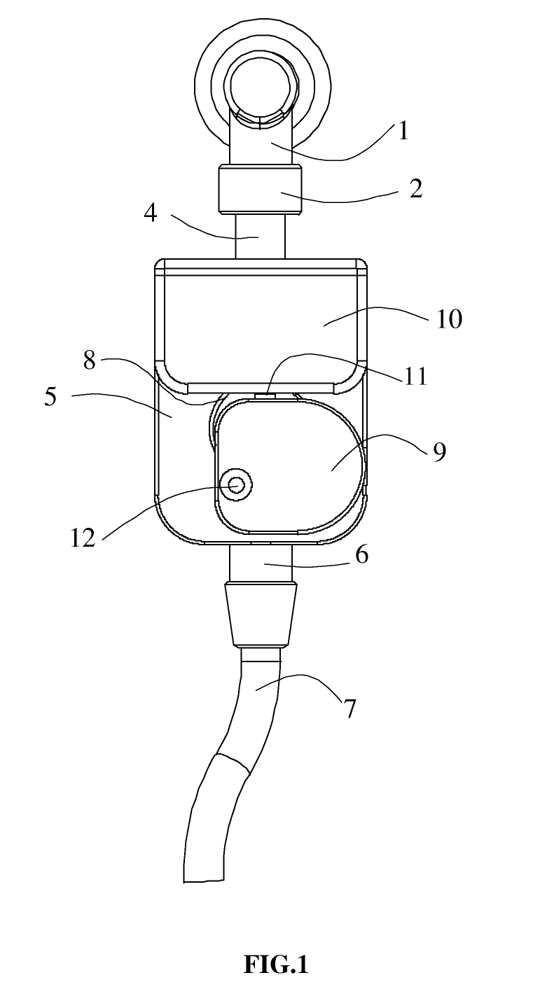

FIG. 1 shows a shower supply elbow 1 to which the device is attached by means of a threaded nut 2 using conventional plumbing seals to create a watertight joint. Downstream of the nut 2 a conduit leads to the turbine inlet 4 which is connected to the turbine housing 5. The turbine outlet 6 then connects the device to shower hose 7. The pump housing 9 and the gearbox housing 8 are mounted on the turbine housing 5 so that the turbine drives the pump at the required rate. The soap reservoir 10 is connected to the pump via connector 11. A control knob 12 is provided to turn the delivery of soap on and off. It should be noted that nut 2 may also be connected to a fixed shower arm or electric shower outlet and that outlet 6 may be connect direct to a showerhead.

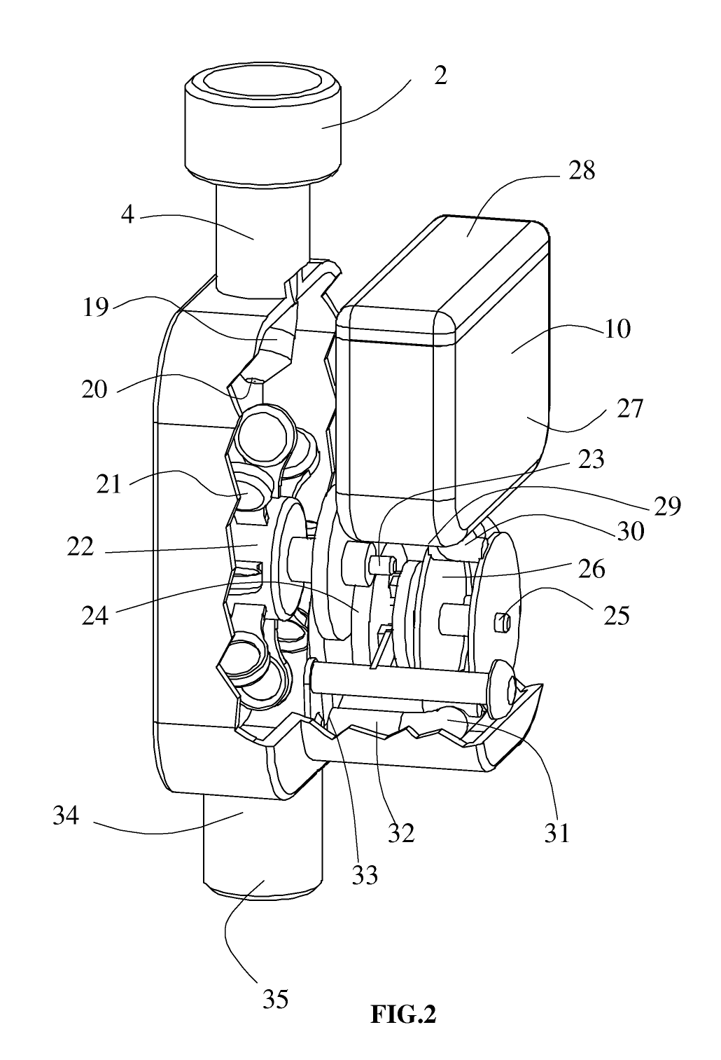

FIG. 2 shows a cutaway perspective view showing more detail of the internal components.

The water enters the device from the supply 1 through nut 2. Nut 2 contains a seal that is clamped against the end of the supply elbow 1 to create a water tight seal. The nut is free to rotate with respect to the device so that the device may be suitable oriented as the nut is tightened.

With water flowing forwards it enters turbine inlet 4 into the jet 19 which accelerates the water flow so that it exits the jet at 20 and is directed upon the turbine blades 21 so causing the turbine 22 to rotate. The turbine 22 is supported on a first shaft 23 which is supported by the housings. Gearbox 24 has its input connected to the first shaft 23 and its output connected to a second shaft 25. Many different types of gearbox may be used but they should be low friction and high efficiency.

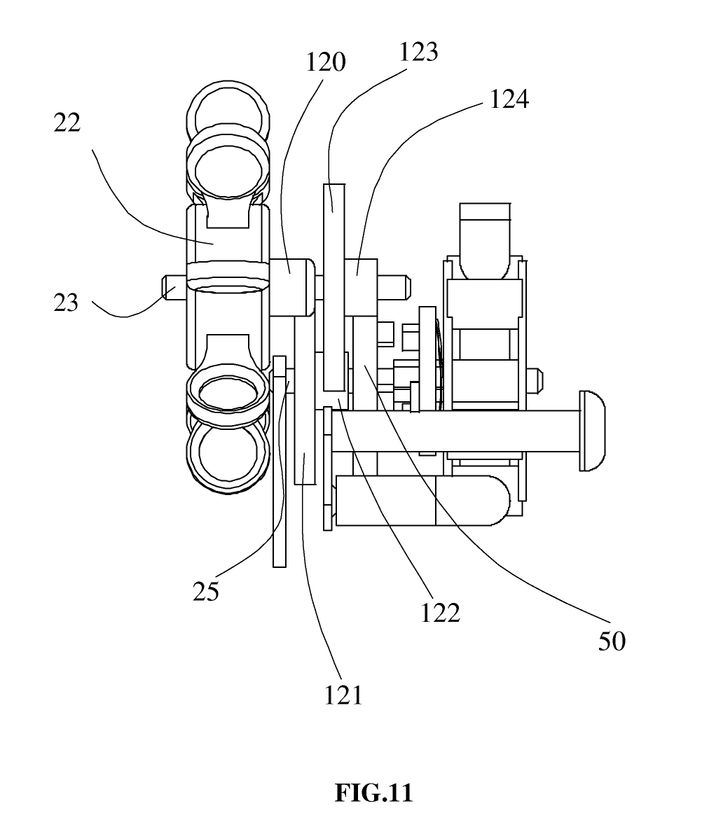

FIG. 11 shows the gearbox 24 which has it's input connected to the first shaft 23 which carries a small spur gear 120 which meshes with a large spur gear 121 which is mounted on the second shaft 25 but free to rotate thereon. Gear 121 carries a first small gear 122 which meshed with larger gear 123 which is mounted on the first shaft 23 but free to rotate thereon. Gear 123 carries a second small gear 124 that meshes with gear 50. This is a 3 stage spur gear box with a ratio of approximately 75:1.

One feature of the preferred embodiment that reduces frictional losses is to house the gearbox and pump inside the wet zone so that it is lubricated by the water and also so the need for any rotary shaft water seal is eliminated which also reduces frictional losses. The second shaft 25 is the input shaft of the pump 26. Again many different types of pump may be used but the preferred embodiment shown uses a peristaltic type because of its positive displacement at low speed and torque and ability to self prime. Also peristaltic pumps do not allow the additive to contaminate the workings of the pump which is desirable when considering the use of a wide variety of substances.

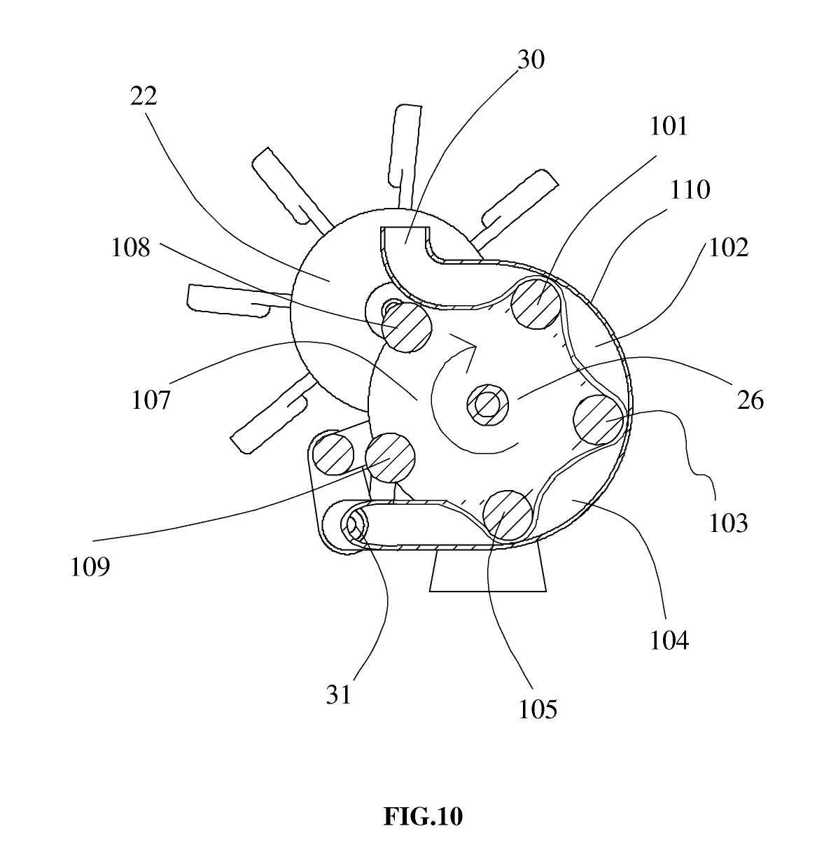

FIG. 10 shows the pump which contains a plurality of rollers 101,103,105,109 and 108 which rotate are mounted to rotate in the direction of the arrow 107. The size of the rollers is such that as they rotate they squash the tube 110 creating sealed volumes along the tube at 102 and 104. These sealed volumes are moved along the tube away from the inlet 30 towards the outlet 31 so pumping the soap.

The soap reservoir 10 comprises a hopper 27 with a lid 28. The fit of lid 28 to hopper 27 is not airtight to prevent a vacuum build up as soap is withdrawn from the reservoir. Soap is poured into the hopper 27 and the lid replaced to prevent water ingress. The hopper is connected to the pump inlet via connector 29 such that the soap is drawn into the pump inlet 30 and pumped out at pump outlet 31. The soap is then forced along connector 32 to reenter the fluid flow downstream of the turbine at soap outlet 33. It is desirable to have the soap reenter the water flow downstream of the turbine to prevent the soap coming into contact too readily with turbine and its workings.

The water leaves the turbine housing via conduit 34 which has a thread 35 on the end to allow attachment to the shower head or other shower device.

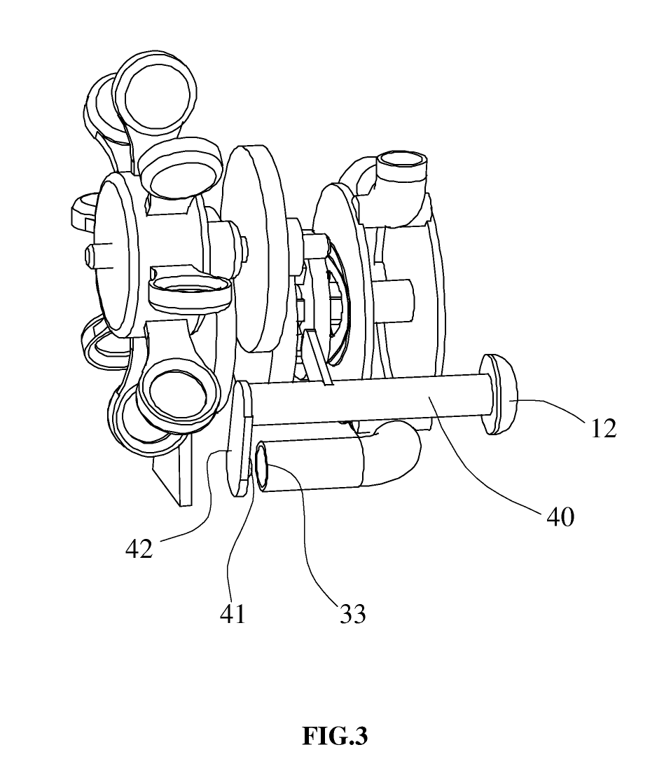

FIG. 3 shows means for turning the addition of soap on and off comprising control knob 12 connected to a plunger 40 which can move axially generally along the same axis as the soap outlet 33. When the control knob is pulled the seal 41 mounted on tab 42 the end of plunger 40 seals against the soap outlet 33 so stopping the flow of soap. In the interests of efficiency the preferred embodiment also provides a clutch mechanism that allows the turbine to freewheel when the soap is not required. This reduces the energy removed from the water flow when the soap is turned off which maximizes the effectiveness of the shower.

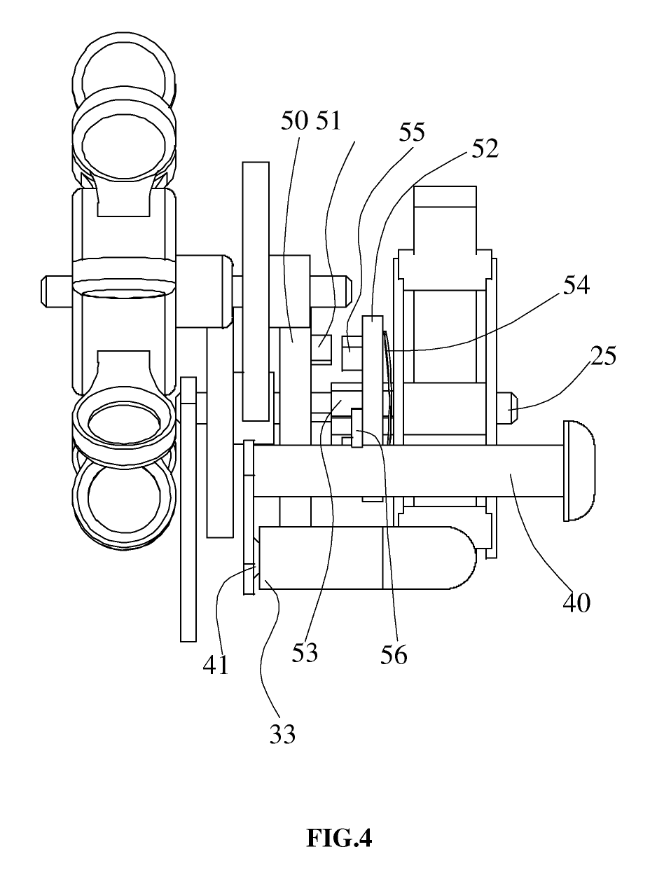

FIG. 4 shows a simple clutch mechanism located in the gearbox 24. The final gear 50 of the gearbox is mounted on the second shaft 25 so that it can rotate with respect to the shaft but so that its axial position with respect to the shaft is fixed. This gear 50 carries a plurality of lugs 51 which face towards the clutch plate 52. The clutch plate 52 is mounted on the pump input boss 53 so that it can move axially with respect to gear 50 but cannot rotate with respect to the pump. The clutch plate 52 is biased towards the gear 50 by a spring washer 54 but in FIG. 4 clutch plate 52 is held away from the gear 50 by tab 56 that is fixed to plunger 40. In this configuration the seal 41 seals the soap outlet 33 and at the same time holds the clutch plate 52 away from gear 50 so that the lugs 51 do not engage with lugs 55 on the clutch plate. When the lugs are disengaged the gear 50 rotates but no torque is transmitted to the clutch plate 52 and therefore the pump does not rotate. This allows the turbine to spin freely thus ensuring that the water may flow as freely as possible to maximize shower performance. The soap outlet 33 is also sealed. It is important that this seal is made in such a way that no residual soap remains where the water can wash it in to the shower. This is so that when the user turns off the soap it is rinsed out of the shower and pump mechanisms as quickly as possible.

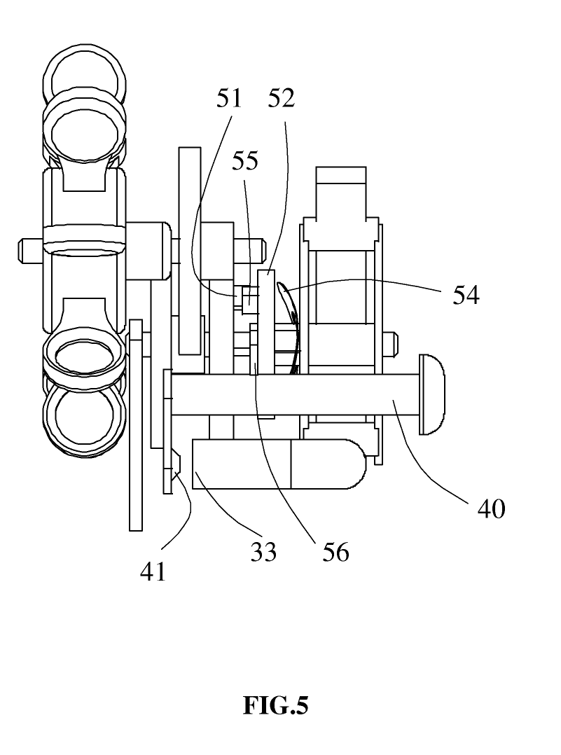

FIG. 5 shows the device with the soap turned on. The control knob 12 is depressed moving seal 41 away from soap outlet 33 and also moving tab 56 thus allowing the clutch plate 52 to move under the influence of spring washer 54 towards and engage with gear 50 so turning on the pump.

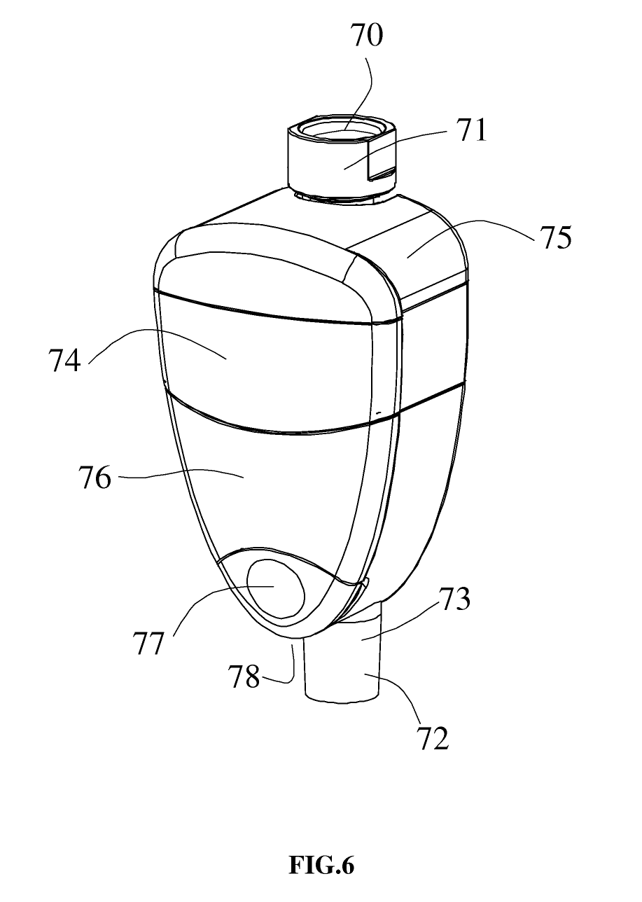

FIG. 6 shows a second embodiment of the device which has been styled to suit the modern shower environment. One of the key features of the design is the female pipe thread 70 contained within nut 71 and the male pipe thread 72 on the outlet 73. These threads match those on the users existing bathroom plumbing and allow quick and easy connection to both the water supply and shower whether it is a shower hose, hand shower or electric shower. This provides for easy DIY installation without the use of tools and the sale of the device as a shower accessory.

FIG. 6 also shows a soap cartridge 74 with a close fitting lid 75. This is positioned above the combined pump and gearbox housing 76. The soap control 77 is situated at the lower edge of the housing 76 and includes a lip 78 that allows the control to be pulled with the finger tips to the off position shown. The control 77 is pull off/push on when used with the clutch mechanism described in FIGS. 4 and 5.

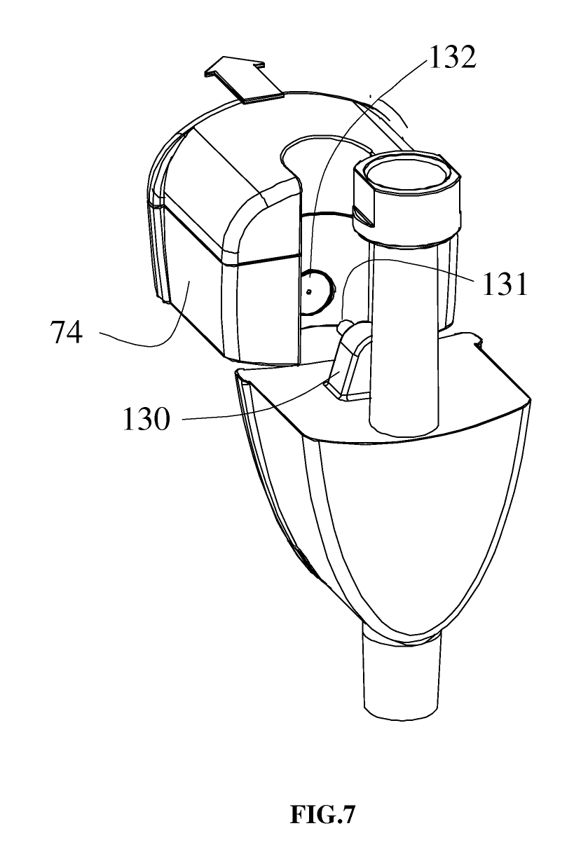

FIG. 7 shows a rear perspective view of the second embodiment with the soap cartridge 74 being removed. The modern shower has many different soap products that the bather may wish to use and it is advantageous to allow the user to change easily from one product to another. In this embodiment the device is supplied with more than one multiple cartridges which can each be filled with a different product. The user then simply ejects one cartridge by pulling in the direction shown by the arrow and replaces it with a different one. It is not necessary to turn off the water to perform a cartridge change.

FIG. 7 shows the soap cartridge 74 and the pump inlet 130. The pump inlet has a tubular spigot 131 with its axis generally aligned with the direction of cartridge removal. The cartridge 74 has a circular self sealing valve 132 as typically found on the closure of shower gel bottles such that as the cartridge is slid into place the spigot 131 penetrates the valve 132 which allows the soap to enter the pump inlet 76. When the cartridge is removed the valve 132 self closes to prevent any soap leaking from the cartridge 74. The new cartridge can then be loaded as required.

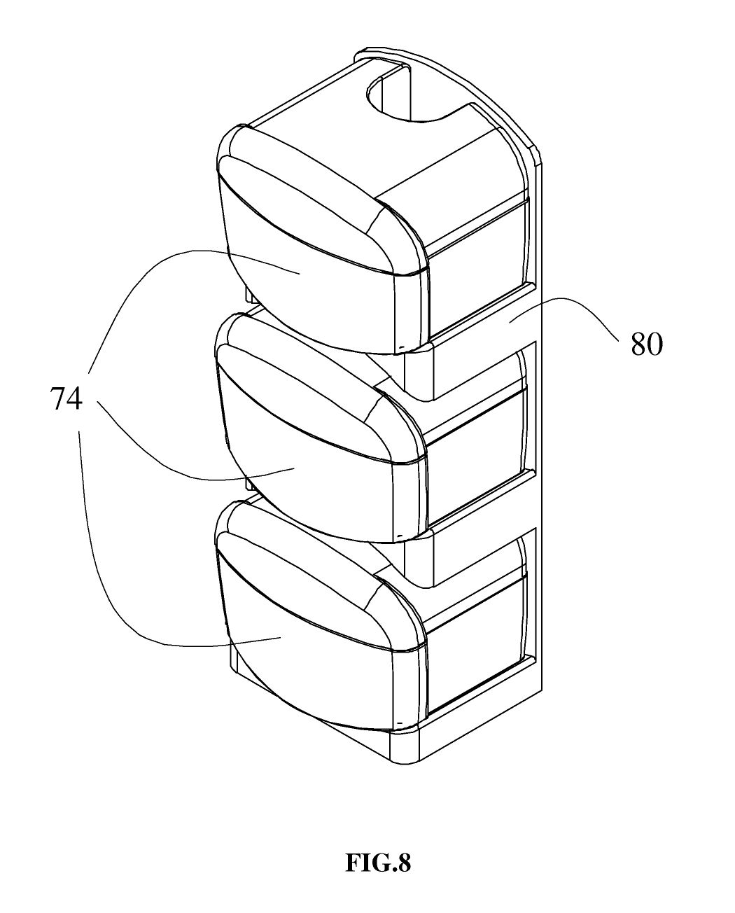

FIG. 8 shows an example of the a caddy 80 designed to organize multiple cartridges 74 which can either be free standing on a shelf or fixed to the tiles with suction cups.

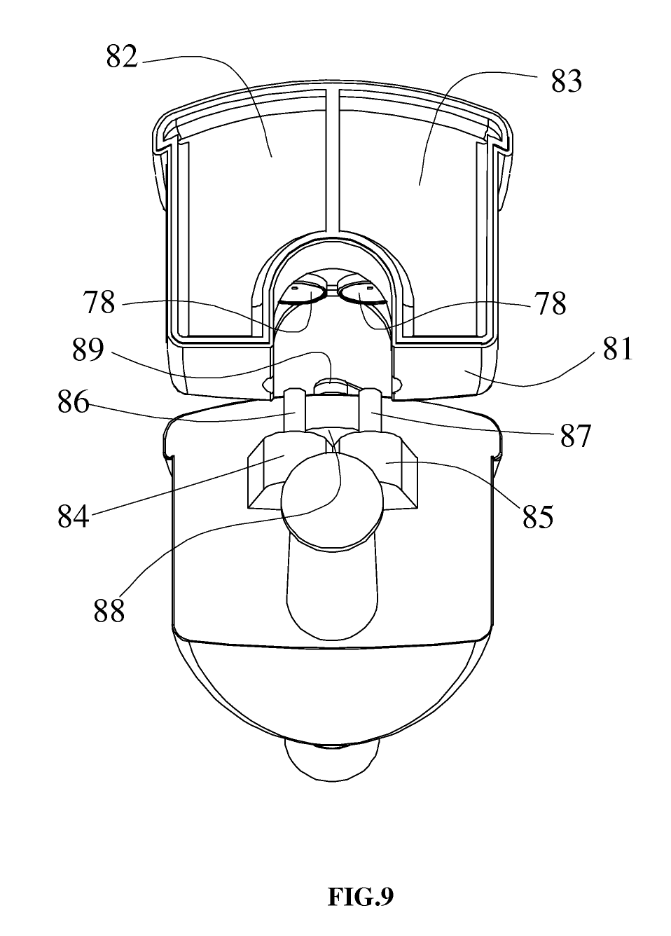

FIG. 9 shows a 3rd embodiment which allows the user to change from one soap to another without needing to change cartridges as described above. In this embodiment a cartridge 81 is divided into two compartments 82 and 83. Whilst this embodiment only shows two compartments this same principle may be used with any number depending on the overall size of the device. Each compartment is equipped with a self seal valve 78 and the pump housing is equipped with a corresponding number of inlets 84 and 85 each equipped with its own spigot 86 and 87. Each pump inlet is connect to selector valve 88 which allows any one of the compartments 82 and 83 to be placed in communication with the pump depending on the position of the selector valve handle 89. A variation of this embodiment uses the same valving principle but splits the multi compartment cartridge 81 into two separate cartridges that sit side by side on the housing; this variation allows any two cartridges to be in use at a time.

The aim of the cartridge principle is to allow the user maximum flexibility in the use of the device.

In other embodiments there are other ways of supplying the soap to the pump. If the soap is sold in custom packaging this can be designed to connect directly to the pump inlet thus eliminating the need for the reservoir. Further more the connection can be designed to ensure that only one manufacturers packing will fit in the same way that certain razors demand that you purchase only the razor manufacturers blades as replacements. Pouches are also a good option for this device as the flexibility of the pouch allows it to collapse in upon itself as the soap is withdrawn from inside. (Note that rigid bottles connected directly to the pump will probably require an air bleed into the bottle to prevent a vacuum being created inside the bottle which could prevent the pump from working.

This invention discloses one method for extracting energy from flowing water and using it to power a pump that can raise the pressure of an additive from ambient to above that of the water flowing within the conduit. It is clear that there are numerous different types of turbine, gearbox and pump that can be used to achieve the same end and the choice of these will depend on the particular application.

In some instances it may not be possible to extract enough energy from the water flow it which case the power supply to the pump may be supplemented by an alternative power source such as a battery driven motor.

While we have shown and described various embodiments in accordance with the present invention, it is clear to those skilled in the art that further embodiments may be made without departing from the scope of the present invention.

What is claimed is:

1. A shower soap dispenser comprising
a turbine including a turbine housing, and the turbine housing including a turbine inlet connected to the turbine housing to flow water inward, a turbine outlet to flow soap outward, a jet disposed therein and communicating with the turbine inlet, and a plurality of turbine blades axially fixed therein and pushed by water flow from the jet to rotate;
a gearbox mounted on the turbine housing and including an input connected to a first shaft of the turbine housing and an output connected to a second shaft to change rotating speed;
a pump including a pump inlet and a pump outlet and driven by the output of the gearbox to operate;
a soap reservoir connected to the pump and used to store soap, and the soap in the soap reservoir being pumped into the pump inlet by the pump and pumped into the turbine outlet from the pump outlet;
a clutch mechanism clutch mechanism located in the gearbox control to engage the turbine with the pump or disengage the turbine from the pump, when the turbine engages with the pump, the pump is turned on by the turbine, when the turbine disengages with the pump, the pump turns off;
means for turning the addition of soap on and off to be pulled or pushed to open or close the soap outlet and to allow the clutch mechanism to engage and to force the clutch mechanism to disengage.

2. The shower soap dispenser as claimed in claim 1, wherein the turbine inlet is connected with a nut, and the nut is used to attach a shower supply elbow with the shower soap dispenser.

3. The shower soap dispenser as claimed in claim 1, wherein the turbine inlet is connected with a nut, and the nut is connected to a fixed shower arm or an electric shower outlet.

4. The shower soap dispenser as claimed in claim 1, wherein the clutch mechanism including a final gear of the gear box mounted on the second shaft and used to carry a plurality of lugs facing toward a clutch plate, the clutch plate being mounted on a pump input boss, biased toward the final gear by a spring washer, and held away from the final gear by a tab of the plunger, and the clutch mechanism also including a plunger having a seal to seal a soap outlet and hold the clutch plate away from the final gear; the means for turning the addition of soap on and off includes a control knob connected to a plunger which can move axially generally along the same axis as the soap outlet, when the control knob is pulled the seal mounted on tab the end of plunger seals against the soap outlet so stopping the flow of soap; the control knob is depressed moving seal away from soap outlet and also moving tab thus allowing the clutch plate to move under the influence of spring washer towards and engage with gear so turning on the pump.

5. The shower soap dispenser as claimed in claim 4, wherein the first shaft carries a small spur gear which meshes with a large spur gear, and the first large spur gear is mounted on the second shaft but free to rotate thereon and carries a first small gear which meshes with a large gear, and the large gear meshes is mounted on the first shaft but free to rotate thereon and carries a second small gear that meshes with the final gear.

6. The shower soap dispenser as claimed in claim 1, wherein the pump includes a plurality of rollers to rotate, and the size of the rollers is such that as they rotate they squash the tube creating sealed volumes along the tubes, these sealed volumes are moved along the tube away from the inlet towards the outlet so pumping the soap.

7. The shower soap dispenser as claimed in claim 1, wherein the soap reservoir comprises a hopper with a lid, the fit of lid to hopper is not airtight to prevent a vacuum build up as soap is withdrawn from the reservoir, and soap is poured into the hopper and the lid replaced to prevent water ingress, the hopper is connected to the pump inlet via connector such that the soap is drawn into the pump inlet and pumped out at pump outlet, the soap is then forced along connector to reenter the fluid flow downstream of the turbine at soap outlet.

8. The shower soap dispenser as claimed in claim 1, wherein the turbine outlet includes male pipe thread formed thereon.

9. The shower soap dispenser as claimed in claim 2, wherein the nut includes female pipe thread formed therein.

10. The shower soap dispenser as claimed in claim 3, wherein the nut includes female pipe thread formed therein.

11. The shower soap dispenser as claimed in claim 1, wherein the soap reservoir is a soap cartridge with a close fitting lid positioned above the combined pump and gearbox housing, and a soap control is situated at the lower edge of the housing and includes a lip that allows the control to be pulled with the finger tips to the off position shown, the soap control is pull off/push on when used with the clutch mechanism.

12. The shower soap dispenser as claimed in claim 1, wherein the pump inlet has a tubular spigot with its axis generally aligned with the direction of cartridge removal, and the cartridge also has a circular self sealing valve as typically found on the closure of shower gel bottles.

13. The shower soap dispenser as claimed in claim 11, wherein the soap cartridge is divided into at least two compartments, and each compartment is equipped with a self seal valve and the pump housing is equipped with a corresponding number of inlets and each equipped with its own spigot; each pump inlet is connect to a selector valve which allows any one of the compartments to be placed in communication with the pump depending on the position of the selector valve handle.

14. The shower soap dispenser as claimed in claim 1, wherein the soap reservoir is connected to the pump via a connector.
